(19) United States
(12) Patent Application Publication
(10) Pub. No.: US 2023/0259888 A1
(43) Pub. Date: Aug. 17, 2023

(54) BLOCKCHAIN-BASED APPOINTMENT MANAGEMENT

(71) Applicant: KYNDRYL, INC., New York, NY (US)

(72) Inventors: Tiberiu SUTO, Franklin, NY (US); Shanthan CHAMALA, Malvern, PA (US); Shikhar KWATRA, San Jose, CA (US); Vinod A. VALECHA, Pune (IN)

(21) Appl. No.: 17/650,789

(22) Filed: Feb. 11, 2022

(51) Int. Cl. G06Q 10/10; G06Q 10/06

(52) U.S. Cl. CPC G06Q 10/1095; G06Q 10/06314; G06Q 10/063116

(57) ABSTRACT

Blockchain-based appointment management is provided by maintaining, in a blockchain network with which a provider and a collection of users engage, a schedule of appointments between the provider and individual users, and managing appointment scheduling (including changing existing appointments) between the provider and user(s) of the collection of users via recordation of blockchain transactions on a blockchain of the blockchain network. The managing includes monitoring travel of a user to a location at which a scheduled appointment between the provider and the user is to occur, the monitoring providing an estimated arrival time of the user to the appointment location, based on the estimated arrival time, an initial anticipated arrival time for the scheduled appointment, and the schedule of appointments, determining change(s) to make to the schedule of appointments, including a modification to the scheduled appointment, and recording the change(s) to the schedule of appointments as transaction(s) on the blockchain.

### BACKGROUND

In today's busy world, there is a chance that an appointment holder will be late for a scheduled appointment or fail to show altogether. There are any number of reasons someone may be late or fail to show for a scheduled appointment, for instance traffic delays, urgent unforeseen issues, or forgetfulness, as examples. By way of example, a patient in transit to, or otherwise rushing to make, a doctor's appointment may be running late and call his or her doctor's office to inform the doctor of the delay in reaching the scheduled appointment on time. In some cases, the doctor's office might be able to accommodate the delay, but in many cases the appointment is canceled and rescheduled to a future date. Such cancellations may come at a cost to the patient and/or the doctor's office.

### SUMMARY

Shortcomings of the prior art are overcome, and additional advantages are provided through the provision of a computer-implemented method. The method maintains, in a blockchain network with which a service provider and a collection of users engage, a schedule of appointments between the service provider and individual users of the collection of users. The method also manages appointment scheduling between the service provider and one or more users of the collection of users via recordation of blockchain transactions on a blockchain of the blockchain network. The appointment scheduling includes changing existing appointments. The managing includes monitoring travel of a user to an appointment location at which a scheduled appointment between the service provider and the user is to occur. The monitoring provides an estimated arrival time of the user to the appointment location. The managing also includes, based on the estimated arrival time, an initial anticipated arrival time for the scheduled appointment, and the schedule of appointments, determining change(s) to make to the schedule of appointments. The change(s) include a modification to the scheduled appointment. Additionally, the managing includes recording the change(s) to the schedule of appointments as transaction(s) on the blockchain.

Further, a computer system is provided that includes a memory and a processor in communication with the memory, wherein the computer system is configured to perform a method. The method maintains, in a blockchain network with which a service provider and a collection of users engage, a schedule of appointments between the service provider and individual users of the collection of users. The method also manages appointment scheduling between the service provider and one or more users of the collection of users via recordation of blockchain transactions on a blockchain of the blockchain network. The appointment scheduling includes changing existing appointments. The managing includes monitoring travel of a user to an appointment location at which a scheduled appointment between the service provider and the user is to occur. The monitoring provides an estimated arrival time of the user to the appointment location. The managing also includes, based on the estimated arrival time, an initial anticipated arrival time for the scheduled appointment, and the schedule of appointments, determining change(s) to make to the schedule of appointments. The change(s) include a modification to the scheduled appointment. Additionally, the managing includes recording the change(s) to the schedule of appointments as transaction(s) on the blockchain.

Yet further, a computer program product including a computer readable storage medium readable by a processing circuit and storing instructions for execution by the processing circuit is provided for performing a method. The method maintains, in a blockchain network with which a service provider and a collection of users engage, a schedule of appointments between the service provider and individual users of the collection of users. The method also manages appointment scheduling between the service provider and one or more users of the collection of users via recordation of blockchain transactions on a blockchain of the blockchain network. The appointment scheduling includes changing existing appointments. The managing includes monitoring travel of a user to an appointment location at which a scheduled appointment between the service provider and the user is to occur. The monitoring provides an estimated arrival time of the user to the appointment location. The managing also includes, based on the estimated arrival time, an initial anticipated arrival time for the scheduled appointment, and the schedule of appointments, determining change(s) to make to the schedule of appointments. The change(s) include a modification to the scheduled appointment. Additionally, the managing includes recording the change(s) to the schedule of appointments as transaction(s) on the blockchain.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 presents a hybrid system/flow diagram of one example of a service in operation in accordance with aspects described herein;

FIGS. 2A-2B depict an example process for blockchain-based appointment management, in accordance with aspects described herein;

FIGS. 3A-3E depict additional embodiments of example processes for blockchain-based appointment management, in accordance with aspects described herein;

FIG. 4 depicts one example of a computer system and associated devices to incorporate and/or use aspects described herein;

FIG. 5 depicts a cloud computing environment according to an embodiment of the present invention; and

FIG. 6 depicts abstraction model layers according to an embodiment of the present invention.

### DETAILED DESCRIPTION

Various problems arise from late or no-show appointment holders. Using the example of a patient late for a doctor's appointment, the patient might contact the doctor's office while driving, which is potentially unsafe, the doctor's office might be busy attending to other patients and miss patient's communication, or the patient might reach the doctor's office with such a delay that the doctor is unable to accommodate the patient, for instance because there are no more appointments available that day or the doctor's office is unable to delay the next-scheduled appointments with other patients. Such issues may result in lost fees to the doctor's office, no-show fees to the patient, and/or lost time to either or both the doctor and the patient.

Varying outcomes may result from these scenarios. As one example, a doctor's office or other provider might hold the user's appointment time if the delay is relatively small and does not impact other appointments. As another example, the doctor's office may be able to swap the delayed patient's appointment with a next or later, same-day appointment. Of course, the doctor's office may not be able to accommodate a given delay and therefore cancels the appointment and suggests that the user reschedule his or her appointment. Other outcomes are possible.

Aspects described herein provide approaches to efficiently keep both a user with an appointment and the provider informed as to the status of an upcoming appointment, for example, anticipated delays, and intelligently attempts possible swapping of appointments (and/or accommodating unscheduled appointments) based on the next scheduled appointments, e.g., the same day, and their estimated times of arrival while information is exchanged between cluster nodes with incentivized schema along a blockchain framework.

Aspects can overcome noted problems by dynamically generating notifications and providing information about a user's updated travel times based on deviation from initial anticipated arrival times, and identifying parties of interest in a blockchain network associated with the appointment engagement, while providing an incentivization strategy as a means for compensating the relevant parties, with a reason for the rescheduling.

Examples discussed herein involve appointments between users and providers. A “provider” can be any type of provider, for instance a service provider. Example types of service providers include (but are not limited) providers of medical, dental, accounting, vehicle maintenance, or real estate services. However, aspects described herein apply as well to appointments between people and other persons, offices, businesses, or other entities.

A significant issue faced by providers who book appointments with users is when late or no-show users (e.g., customers and patients) do not show up for a scheduled appointment and/or do not call or otherwise inform the provider in advance about late arrival or not attending the appointment. This leads to wasted time and money for those involved, including lost revenue of the provider, as that time slot could have been filled with another user, and no-show fees to the user. Some appointment scheduling software includes a pre-payment feature that requires a user to pay for a scheduled appointment at the time of booking. This can help reduce no-shows because users generally do not skip paid appointments. However, while such an arrangement may work in some scenarios, in others, paying upfront at booking may not be very popular with users. In fact, some users may change providers over such a policy.

Alternatively, some software offers a feature of sending automatic reminders in the form of email or text to the clients, which contributes to reducing the number of no-shows. Moreover, after deploying appointment scheduling software, users have fewer phone calls and emails to answer, staff at a provider's place of business can utilize more time to help improve the business as well as efficiency instead of calling people back, filling out paperwork for new customers, collecting payments, or figuring out who is or is not coming to the next appointment. This significantly reduces the administrative work, which can help in focusing on improving user experience. Owing to these and other factors, the demand for appointment scheduling software is increasing in the market.

Aspects described herein go beyond existing appointment management solutions. In some embodiments, a service includes an aspect to track a user's location prior to the appointment time, for example, on a route from an initial location such as the user's home to the appointment location. The service can seek to solve rescheduling issues prior to the appointment time. In some examples, the service incorporates an incentivization schema that encourages other users to change their appointments in favor of a user running late. Both users and providers (or their representatives) can opt into an automatic appointment management service. In one example, the service may be run on a cloud server to which the user, using a mobile application (or other software) and the provider or the provider's staff, using an application (such as a mobile application or other computer software) all have access in their respective roles within operation of the service.

When time for a user to leave an initial location to travel to an appointment, and/or when the user is in transit to the appointment, the user's mobile application for accessing the service can automatically send a notification to the user and initiate an automatic navigation function, for example through the application, through another application, or using navigation software included with a vehicle. If during a drive to an appointment location, traffic conditions change or for some other reason there is a delay that may cause the user not to arrive at the initial, anticipated time for arrival to participate in the schedule appointment, the application may, for example, automatically and dynamically estimate the late arrival time and notify the provider or, as another example, contact an appointment service through an API (Application Programming Interface) and transmit the updated estimates arrival time. For example, if the user had an appointment at 9:30 AM and they are projected to arrive at 9:45 AM, the application may send the 9:45 AM updated arrival time and await a reply from the provider or the appointment service.

Depending on any thresholds the provider may have set up with the service (e.g., no accommodation beyond 15 minutes of the appointment time) and the provider's current schedule of appointments, the appointment management system can respond accordingly. Example responses include:

a. The provider, directly or indirectly (e.g., via provide policies) accepts the updated arrival time and the user continues to the appointment. In other words, the user's delay can be accommodated by the provider.

b. The system counters the original appointment time with another appointment time that is around that time on the same day and which will maximize doctor's ability to see patients. This may be first attempted by the service without employing an incentivization schema. In the example above, if a patient with a 10:00 AM appointment was already in the office at 9:30 AM, the service could automatically swap that user's appointment with the 9:30 AM appointment, giving the 9:30 appointment to the patient already present and giving the delayed patient the 10:00 AM appointment.

c. If none of the above provides a satisfactory option for the user, the system may, in one example, offer an incentivization option to try to secure an appointment of another user that may have a more flexible schedule and/or a desire for the incentive. For example, in this scenario, assume the patient is estimated to miss the 9:30 appointment by 15 minutes and the doctor cannot rebook the user for a week, for example, due to the patient load prior to the next available appointment. The system notes based on the user's calendar that the user is also scheduled to fly out this evening, so the user would ideally want to see the doctor before their trip. At this point, the system may employ incentivization of other user(s) to try to secure an alternate appointment. For example, the system may identify that user B and user C, currently scheduled for 1:00 PM and 3:00 PM today, respectively, have flexible schedules and may be likely to accept changing their appointment to a different time that day or another day. The system can derive an incentive value based on one or multiple factors including, for example, the length of time the other users, here users B and C, may be inconvenienced by having their own appointment being delayed, the availability of an open appointment at the same time the other user is available. In this instance, the system offers each of users B and C $10 (e.g., in cryptocurrency) to switch their appointments with the provider to an appointment available next week. If neither B nor C accepts this initial offer (for instance they deem the inconvenience too great for the proposed incentive), the system can revise the initial incentive to offer an updated amount of $20. If a user (e.g., user C) accepts the offer, then at this point the system can process the appointment changes giving user A the appointment time of user C, rebook user C to a next mutually available timeslot, and automatically send $20 from, for example, user A's cryptocurrency wallet to user C's cryptocurrency wallet.

Although other forms of currency may be used, for example, U.S. dollars, in any case the system is preferably allowed access to the currency accounts of all users and possibly the provider if they were to receive any user payment. In one example, this permission and the relevant account information is given at the time of opting into the appointment management service. In another example, though less efficient, the system may prompt users for access when needed or at some fixed time interval.

In one example, the users participate in one or more blockchain network(s) for schedule management and payments among those involved, enabling scheduling, rescheduling, and incentivization transactions to be tracked. The blockchain networks for schedule management and payments could be the same or different blockchain networks. Using blockchain technology, all transactions between the users may be, for example, secured, resilient, and accurately recorded and tracked. Additionally, the same transactions may be reported to the scheduling administrator(s) of the provider to complete the rescheduling and make sure everyone has the updated information for rescheduled appointments. In some aspects, calendaring/appointment scheduling software of the provider and users can sync with blockchain network(s), enabling appointment creation, change, and cancellation/deletion in the software or on the blockchain (e.g. via transactions) to be synced with the other. In a specific example, change(s) to a schedule of appointments are determined and reflected in transactions(s) on a blockchain of the blockchain network, and those changes can be synced to the appropriate entities, for instance service provider calendaring/appointment software and/or user calendars.

A blockchain is formed of blocks of records secured using agreed-upon cryptographic protocols. Records can correspond to logged transactions. A block contains secured information about a previous block, thus forming a chain. Changes to an existing block would lead to an inconsistency with the information contained in a subsequent block, and therefore ensures that transactions are verifiable and immutable. Blockchains can be managed in a distributed (e.g., peer-to-peer) fashion by way of a distributed ledger. The ledger can be maintained in a consistent fashion across nodes according to protocol(s) for communicating and validating new blocks.

In one example, as part of the blockchain network, blockchain node information can be used to track the schedules associated with the users and provider(s). There may be a logistic regression model running on a blockchain node, e.g., a smart contract may identify whether an anomaly or deviation is predicted from the ideal scheduled time frame, in which case the smart contract can highlight a deviation flag in one of the collaborating nodes, triggering transacting to make changes to the scheduling, and creation of a new node based on negotiation of the cluster of end user nodes interacting with each other in, for example, a consensus framework.

Blockchain-based smart contracts can be partially or fully executed or enforced without human interaction. An objective of a smart contract may be automated escrow, and a key feature of a smart contract may be that there is no need for a trusted third party (such as a trustee) to act as an intermediary between contracting entities since the blockchain network executes the contract on its own. This may reduce friction between entities when transferring value and could subsequently open the door to a higher level of transaction automation.

In one example, a provider can initially set and/or subsequently change one or more thresholds or policies for the service to use in scheduling/rescheduling users having appointments with the provider. One example such threshold is a rescheduling threshold, i.e., a ‘maximum lateness’ threshold set by the service provider, indicating a delay at which to trigger rescheduling an appointment based on late user arrival. This represents a threshold of time from the appointment time to a late arrival time up to which a user may be late before the user forfeits the appointment and must reschedule, for instance to a later time the same day or to a later day. Whether to reschedule the user's appointment may be based on mutual availability of the user and the provider. In addition, at service setup with the provider or a later time, the provider may have, for example, options for the service to maximize or minimize the number of appointments on a given day, during particular hours or during some other time frame.

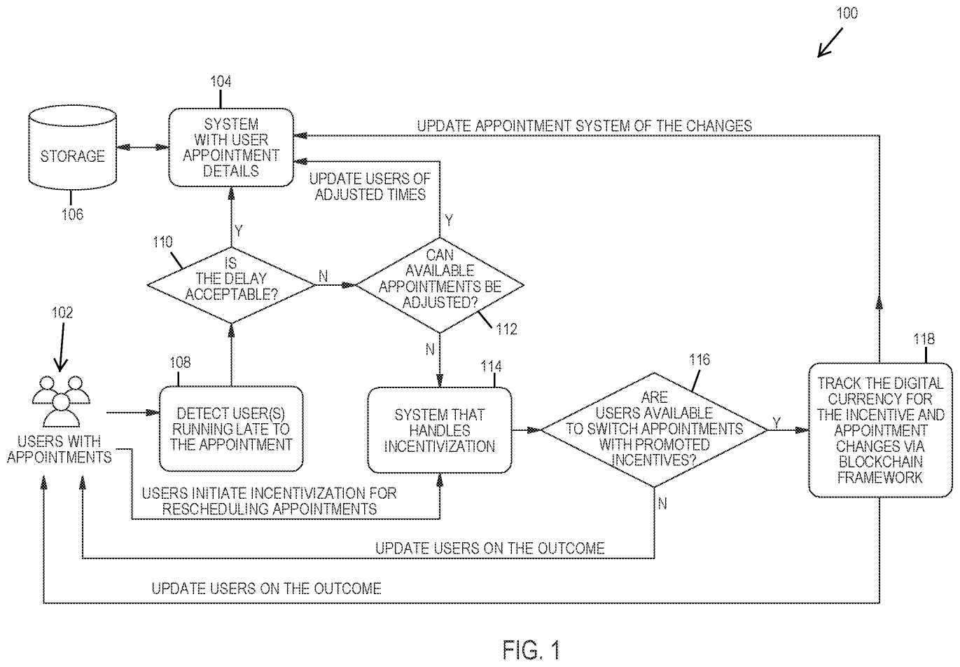

FIG. 1 presents one example of a hybrid layout and flow diagram 100 for one example of the design and workflow of an appointment management service in accordance with one or more aspect of the present invention. A plurality of users 102 each has a unique appointment with a provider (not shown). A schedule for each of the users and the provider is made available to the service upon opting into the service. In one example, the schedules are made available from a scheduling system 104 and stored in storage 106 (e.g., a database). The schedule for a given user may be made fully accessible to the service or partially accessible (e.g., only certain types of appointments). Full accessibility to the service may be more efficient for rescheduling appointments. In one example, full accessibility may be limited to a time frame chosen by the user or provider initially or be based on a privacy or other policy of the service as another example.

The service detects 108 when a user is running late to an appointment with the provider. In one example, tracking may be accomplished using U.S.-based satellite positioning navigation and timing known as GPS (Global Positioning System) or similar (e.g., Galileo (European Union) or GLONASS (Russian)), for example through an application on the user's mobile device. In one example, the application may be that of the service or could be available to the service via an API (Application Programming Interface) or other interfacing software. For privacy reasons, the tracking need not be at all times, but triggered by some time frame prior to the scheduled appointment with the provider.

An inquiry 110 is then made as to whether the delay of the user is acceptable to the provider, in other words, determining whether the delay can be accommodated by the provider. Accommodation can be determined in a number of ways. For example, accommodation determinations could be based on one or more policy of the provider made known to the service or parameters set by the provider, e.g., concurrent with opting into the service, with respect to late arrivals (e.g., delays of more than 15 minutes cannot be accommodated). Accommodation could, as another example, be determined by contacting the provider if the delay is within provider policy limits. If the delay is acceptable or can be accommodated (110, Y), then the service may also notify the user and provider (e.g., notifying the user and designated staff at a provider's office via text, email, instant message, etc.) and optionally reflect this in the schedule(s) of the user and/or provider in the scheduling system 104.

If the delay cannot be accommodated by the provider (110, N), then the service determines whether appointments on the same day as the user's appointment are available or can otherwise be adjusted 112. For example, if another user is early to a next appointment time with the provider after that of the late user, the appointment times can be swapped, allowing both users to have an appointment with the provider. Assuming such a swap is possible (112, Y), the change in appointments is then populated to the user and provider's schedules in the scheduling system 104.

However, if available appointments cannot be swapped (112, N), the service employs an incentivization schema via incentivization system 114 to engage in one or more rounds of incentivized rescheduling. In incentivized rescheduling, other user(s) are presented with an incentive to encourage them to change their appointment in favor of the late user. If no user accepts an incentive to relinquish their appointment to the user, then the incentive presented can optionally increase in value. This can repeat for multiple rounds. An inquiry 116 is made as to whether there are users available to switch appointments with a promoted incentive. If not, the later user is updated with the outcome and the appointment to which the user is running later may be cancelled. In embodiments, the service might automatically reschedule the late user to another day and time that is mutually available to the late user and the provider.

Assuming a reschedule occurs, the schedules of the user and provider can then be updated, for instance to populate the rescheduled appointment as a new appointment on each schedule. If the incentivized rescheduling is successful (116, Y), the incentive may be transferred in some manner from the user to the other user accepting the offer. For example, cryptocurrency or other digital payment could be used and tracked (118) using a blockchain framework. The user, other user who relinquished the appointment to accept the incentive, and the provider can all be notified of the appointment changes, e.g., as two changes for the provider, one change for the other user, and another change for the late user.

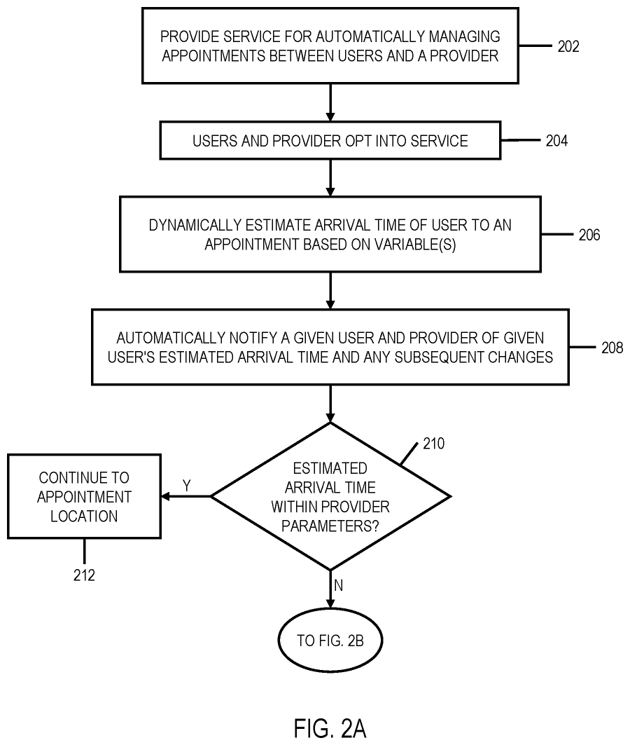

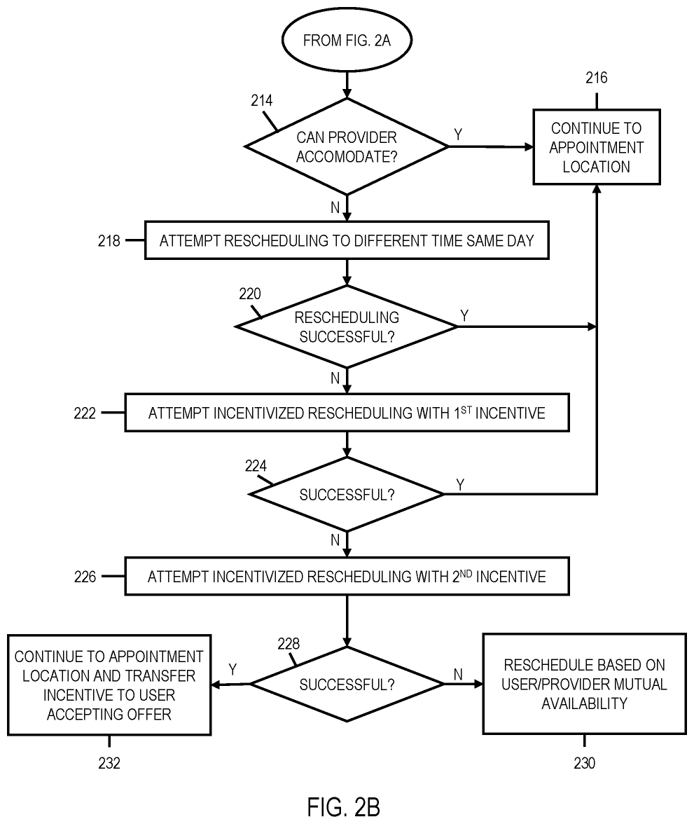

FIGS. 2A-2B depict an example process for blockchain-based appointment management, in accordance with aspects described herein. Initially, the process provides (202) a service for automatically managing appointments between users and providers. In one example, a provider hires the service and users participate in the service. In another example, both the users and providers pay for the service, e.g., users sign up through a mobile app for the service and providers (or their support staff) sign up through an online portal. In operation, both users and providers must first opt into (204) the service, for example after being presented with a clear privacy policy, including a disclosure of any audio or video recordings routinely made.

The service dynamically estimates (206) an arrival time to an appointment with a provider for a user based on, for example, one or more variables 206. The service automatically notifies (208) a given user and provider of the user's estimated arrival time and any subsequent changes thereto, and determines (210) whether the estimated arrival time is within provider parameters/policies set by the provider, for instance a policy on user lateness to appointments and the ability of the provider to accommodate the lateness. If the estimated arrival time is within such parameters or policies or is otherwise indicated as accommodatable (210, Y), then the user continues (212) to the appointment location (e.g., the doctor's office).

Otherwise, if the estimated arrival time later than the scheduled appointment time is outside of provider parameters/policy (210, N), or for any other reason, the process continues to FIG. 2B where it is determined (214) whether the provider can accommodate the estimated arrival time. If the provider can accommodate the estimated arrival time (214, Y), the user continues (216) on to the appointment location. If the provider cannot accommodate the estimated arrival time of the user (214, N), the service attempts to reschedule (218) in the near term, for example, on the same day as the original appointment. The process then determines (220) whether the rescheduling was successful. If the rescheduling was successful (220, Y), the user continues (216) on to the appointment location. One example of a rescheduling scenario involves another user with an appointment following the late user arriving early at the provider appointment location, in which case the service can swap the late user and another user's appointment times.

If the rescheduling was not successful (220, N), the service employs an incentivization schema with successive rounds of increased incentives. In one example, the service may identify one or more other users with appointments near in time to the original appointment and who appear to the service to have flexibility in their schedule that day. In a first round of incentivized rescheduling, the process offers (222) a first incentive to those users identified as potentially amenable to changing their appointment for the first incentive. The process determines at 224 whether the first round of incentivized rescheduling was successful. If the first round was successful (224, Y), the user continues (216) on to the appointment location. If the first round was not successful (224, N), the process attempts (226) a second round with, for example, the users that were offered the first incentive, and the process offers a second incentive (e.g., a larger amount of money, $20 versus $10 in the first round) to encourage a schedule change to open up a slot for the late-running user. The process determines (228) whether the second round was successful. If the second round with the second incentive was not successful (228, N), the appointment is cancelled and the user may be rescheduled (230) based on user and provider mutual availability at a later date/time. If instead the second round was successful (228, Y), then the user continues (216) on to the appointment location at the appointment time given up by the incentivized user and, in some manner, the incentive offered is transferred from the late user to the user accepting the offer.

In one example, cryptocurrency or other form of electronically transferrable currency, for example, tracked on a blockchain network, may be used to compensate the user relinquishing the appointment in favor of the late-running user. Although any number of rounds of incentivization attempts is possible, the present example stops after two rounds for simplicity, and the late user is rescheduled to later date/time, if possible, and on user/provider mutual availability.

The incentive examples above focused on monetary incentives, the amount increasing with each round. However, the incentives could instead be other than monetary, for instance anything else of value. For example, the incentive could be concert tickets that move progressively closer to the stage with each successive round of incentivization. As another example, the incentive could take the form of restaurant meals from fast food to fine dining.

In these examples, the service has, for example, a four-tiered approach to take when estimated arrival time is later than the time of the schedule appointment, in order of preferred approach: provider accommodation of the delay (essentially no rescheduling); rescheduling with the provider based on a near-term opening in the provider's schedule or on swapping with a user holding another near-term appointment; incentivized rescheduling; and rescheduling to future, longer-term date and time mutually available to both the user and provider. Provider accommodation of a delay can be ascertained and potentially automatically selected. For instance, provider accommodation could be selected without a need to contact the provider or the office if the parameters/policies of the provider are such that no verification to accommodate the delay is needed from the provider. Alternatively, a provider may instead require that the service contact (e.g., via automated call, text, email or through an application provided by the service) the provider, office, or representative in this situation to confirm whether the delay can be accommodated. In still another example, accommodation can be some combination of the two, for example, only contacting the provider if there are no or insufficient parameters or policies.

Accordingly, in some embodiments, a computer-implemented method can include providing a service that automatically manages a plurality of appointments between a plurality of users and a provider, the service using a first blockchain network common to the plurality of users and the provider in order to automatically track a schedule for each of the plurality of users and the provider, opting into the service by each of the plurality of users and the provider, dynamically estimating, by the service, for each of the plurality of appointments and based on at least one variable, an arrival time of a corresponding user to a corresponding appointment of the plurality of appointments with the provider, resulting in an estimated arrival time, automatically notifying, by the service, the corresponding user and the provider of the estimated arrival time and any subsequent changes to the estimated arrival time, based on a change to the estimated arrival time of the corresponding user, automatically determining, by the service, whether the provider can accommodate the change to the estimated arrival time, resulting in an accommodation outcome, and based on the accommodation outcome, attempting automatically rescheduling, by the service, of the corresponding user to obtain a different appointment with the provider, the automatically rescheduling including a plurality of rescheduling options, the plurality of rescheduling options including automatically employing an incentivization schema to reschedule the corresponding user to a different appointment with the provider based on a second blockchain network common to all users and the provider for tracking payments therebetween.

The method could further include, prior to employing the incentivization schema and based on the accommodation outcome, automatically attempting rescheduling, by the service, of the corresponding user to a different appointment time with the provider based on a rescheduling option, resulting in a rescheduling outcome, where the automatically employing includes, based on the rescheduling outcome, automatically employing, by the service, the incentivization schema to attempt rescheduling the corresponding user to a different appointment time with the provider, resulting in an incentivized rescheduling outcome. Additionally, the method could further include, based on the incentivized rescheduling outcome, automatically rescheduling, by the service, the corresponding user to a different appointment with the provider based on mutual availability.

Additionally or alternatively, the method could further include automatically tracking, by the service, a location of one, multiple, or each of the plurality of users while in transit to an appointment location of a corresponding appointment with the provider, where the at least one variable includes a current location of the corresponding user and current traffic conditions for the corresponding user in transit to the appointment location. Navigation instructions to the appointment location can be controlled by the service, and, based on the automatically rescheduling, the service can cause the navigation instructions to end.

Additionally or alternatively the corresponding user and the provider can each have a cryptocurrency account made accessible to the service as part of the opting into the service, and the incentivization schema can include at least one round of offering an amount of cryptocurrency from the corresponding user to at least one other user of the plurality of users in exchange for rescheduling an upcoming appointment of the at least one other user with the provider in order for the corresponding user to have the upcoming appointment. Additionally or alternatively, the incentivization schema can have at least one selected from the group consisting of: a maximum number of the at least one round, a maximum payment amount, and a maximum time frame for employing the incentivization schema.

Systems that include a memory, a processing circuit in communication with the memory, and program instructions executable by the processing circuit via the memory, and computer program products that include a computer readable storage medium readable by a processing circuit and storing instructions for execution by the processing circuit, to perform/for performing aspects described herein are also provided.

Location based services (LBS) are software services that use location data to control functionality of computer systems LBS information services have a number of uses, e.g., in social networking, entertainment, security, and in a plurality of additional applications. LBS services employ location services for locating mobile computer systems. Location services can incorporate a variety of different locating service technologies such as the Global Positioning System (GPS), cellular network locating technologies, and WI-FI based locating technologies, and other technologies. One example of an LBS is a location-based messaging services wherein notifications and other messages to users can be in dependence on the respective locations of the users.

Data structures may be employed for improving operation of a computer system used by the service. A data structure refers to an organization of data in a computer environment for improved computer system operation. Data structure types include containers, lists, stacks, queues, tables, and graphs. Data structures may be employed for improved computer system operation, e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

A weather service system can be configured to provide weather data with respect to travel of a user that may affect traffic, for example, and change the user's estimated arrival to a provider appointment location. Weather data can include e.g., historical temperature data, precipitation data, wind data and weather event data. Weather data can include e.g., current temperature data, precipitation data, wind data and weather event data. Weather data can include e.g., forecast temperature data, precipitation data, wind data and weather event data. Weather events can include e.g., storms including hurricanes, tornados, fog formations, heat waves and cold waves. Such a weather service system can store weather data associated to different subareas of an area being serviced by system.

A Natural Language Processing (NLP) process could be used for text-based or voice-based responses to the service from users and providers, or to process data for preparation of records that are stored in some data repository or database and for other purposes. Such a Natural Language Processing (NLP) process can determine one or more NLP output parameter of a message. NLP processes can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters e.g., one of more “social tendency” NLP output parameter or one or more “writing style” NLP output parameter.

By running such a NLP process, a number of processes can be performed, including one or more of (a) topic classification and output of one or more topic NLP output parameter for a received message (b) sentiment classification and output of one or more sentiment NLP output parameter for a received message or (c) other NLP classifications and output of one or more other NLP output parameter for the received message. As noted above, such a message can be, for example, text-based or voice-based.

Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.”

Running such an NLP process can return NLP output parameters in addition to those specification topic and sentiment, e.g., can provide sentence segmentation tags, and part of speech tags. Also, sentence segmentation parameters can be used to determine, e.g., that an action topic and an entity topic are referenced in a common sentence for example.

Various available tools, libraries, and/or services can be utilized for implementation of predictive model(s) for use with the appointment management service. For example, a machine learning service can provide access to libraries and executable code for support of machine learning functions. A machine learning service can provide access to a set of REST APIs that can be called from any programming language and that permit the integration of predictive analytics into the application for the appointment management service. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service provided by IBM® WATSON® can provide access to libraries of APACHE® SPARK® and IBM® SPSS® (IBM® WATSON® and SPSS® are registered trademarks of International Business Machines Corporation and APACHE® and SPARK® are registered trademarks of the Apache Software Foundation. A machine learning service provided by IBM® WATSON® can provide access set of REST APIs that can be called from any programming language and that permit the integration of predictive analytics into any application. Enabled REST APIs can provide e.g., retrieval of metadata for a given predictive model, deployment of models and management of deployed models, online deployment, scoring, batch deployment, stream deployment, monitoring and retraining deployed models. Training such predictive model(s) can include use of e.g., support vector machines (SVM), Bayesian networks, neural networks and/or other machine learning technologies.

Certain embodiments herein may offer various technical computing advantages involving computing advantages to address problems arising in the realm of computer networks. Particularly, computer networks operating to provide appointment management services and/or location-based services (LBS). A fundamental aspect of operation of a computer system is its interoperation to which it operates including human actors. By increasing the accuracy and reliability of information presented to human users, embodiments herein increase the level of engagement of human users for enhanced computer system operation. Provided herein according to one embodiment, are processes that permit a user/location to be updated automatically, e.g., en route to a provider appointment location.

Various decision data structures can be used to drive artificial intelligence (AI) decision making, such as decision data structure that, based on explicit user opt-in, cognitively maps social media interactions in relation to posted content in respect to parameters for use in better allocations that can include scheduling indications of users that are not present in the scheduling system. Decision data structures as set forth herein can be updated by machine learning so that accuracy and reliability is iteratively improved over time without resource consuming rules intensive processing. Machine learning processes can be performed for increased accuracy and for reduction of reliance on rules-based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing, such as scheduling items. Embodiments herein can examine data from diverse data sources such as data sources that process radio signals for location determination of users. Embodiments herein can include artificial intelligence processing platforms featuring improved processes to transform unstructured data into structured form permitting computer-based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

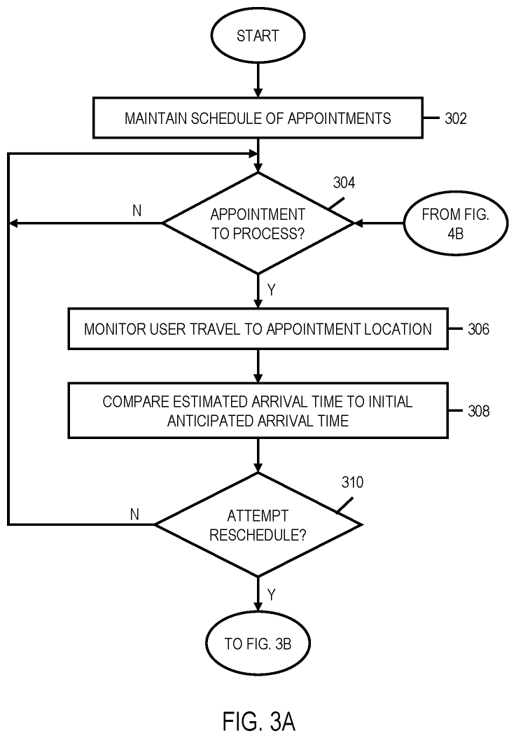

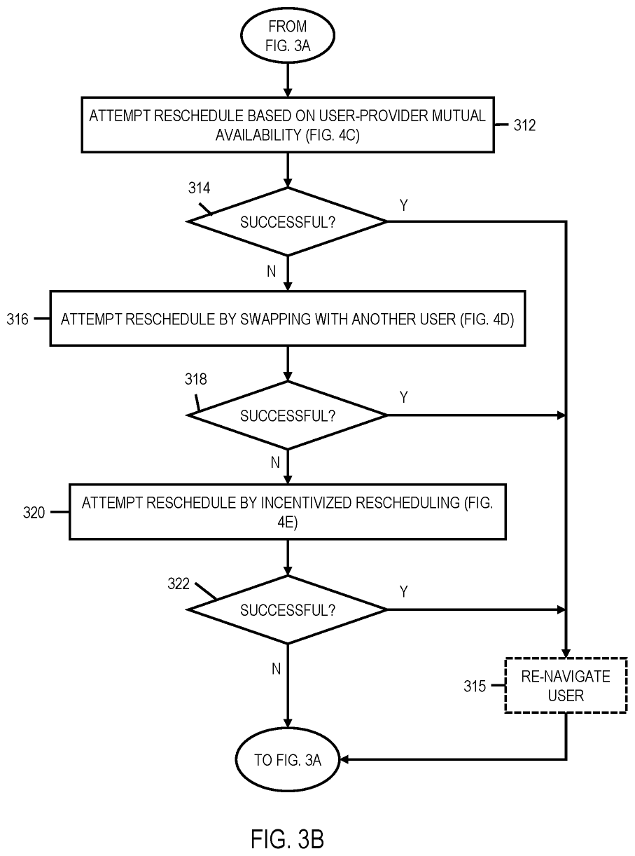

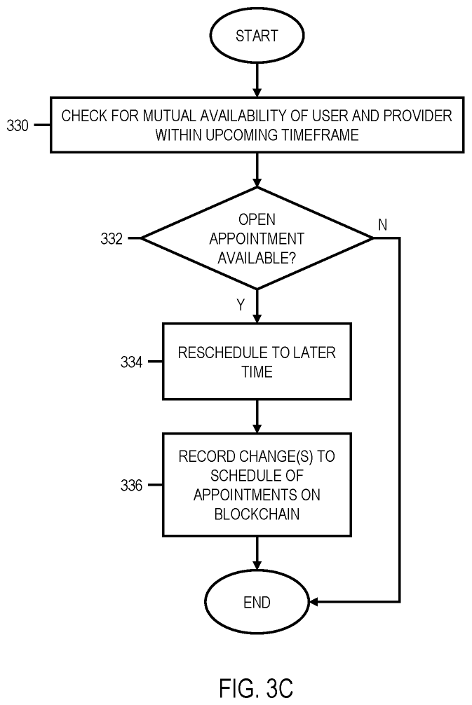

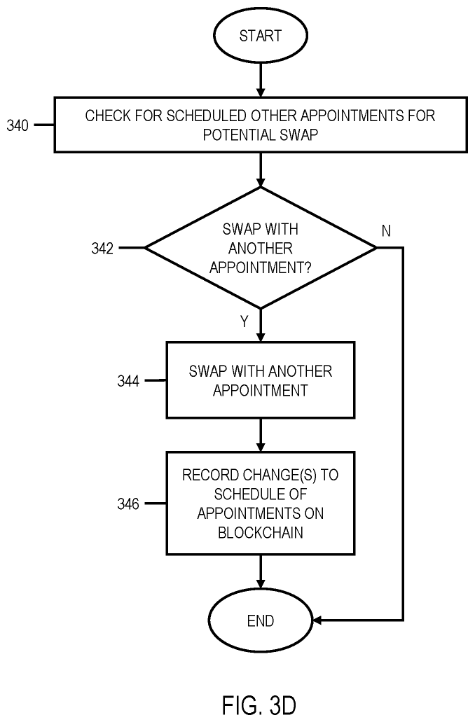

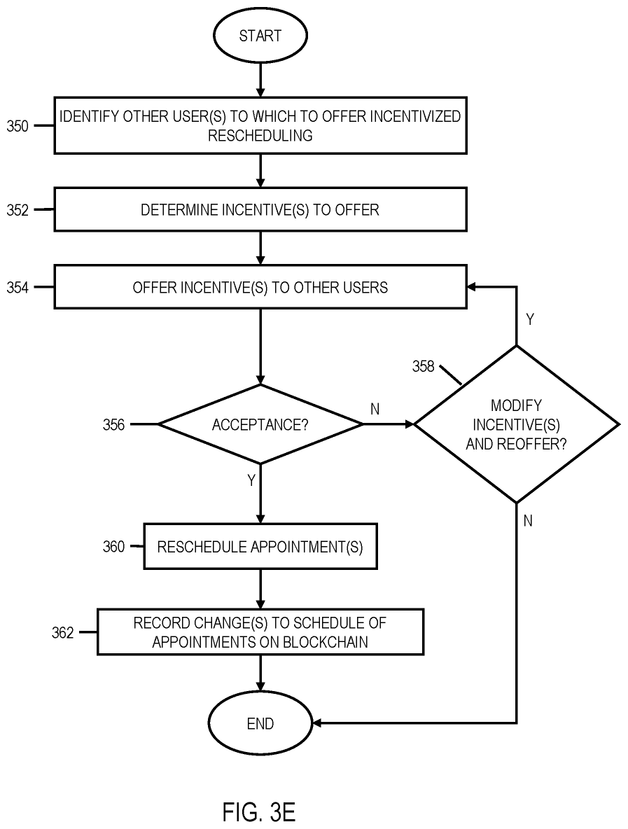

FIG. 3A-3E depict additional embodiments of example processes for blockchain-based appointment management, in accordance with aspects described herein. In some examples, such processes are performed by one or more computer systems, such as those described herein, which may include one or more computer systems of a provider, user, a service providing aspects described herein, one or more cloud servers, and/or one or more other computer systems, as examples.

Referring initially to FIG. 3A, the process maintains (302), in a blockchain network with which a service provider and a collection of users engage, a schedule of appointments between the service provider and individual users of the collection of users. In examples, a service of the blockchain network syncs with calendar(s)/schedule(s) of the service provider and optionally the users.

The process proceeds by managing appointment scheduling between the service provider and one or more users of the collection of users. The scheduling management may be via recordation of blockchain transactions on a blockchain of the blockchain network. Appointment scheduling in this context can include scheduling of new appointments and/or changing existing appointments, for instance through incentivized and other rescheduling activity. In examples, the management is via recordation of blockchain transactions in that determined changes to make schedule(s) of the provider and/or users may be reflected as transactions on the blockchain. The changes may be pushed or otherwise communicated between the blockchain and software of the provider and/or users, for instance calendaring or appointment scheduling software.

The management can include monitoring the status user travel to scheduled appointments with the provider. For example, at or about a time when a user is expected to be traveling to an appointment location, the appointment can be processed to determine the user's progress to the appointment location and whether the user is expected to arrive late for the appointment. Thus, the process of FIG. 3A determines (304) whether there is an appointment to process in this regard. If not (304, N), the process loops back to 304. In this manner, the process of FIG. 3A waits until there is a scheduled upcoming appointment to which a corresponding user is expected to begin traveling. When it is determined that there is a scheduled appointment to process (304, Y), the process of FIG. 3A continues by monitoring (306) travel of a user to an appointment location at which the scheduled appointment between the service provider and the user is to occur. This monitoring provides an estimated arrival time of the user to the appointment location. This estimated arrival time given the user's travel situation is compared (308) to an initial anticipated arrival time for the scheduled appointment. In this regard, the initial anticipated arrival time might be taken as the start time of the appointment (e.g. 9:00 AM for a 9:00 AM appointment) or might be taken as a set amount of time (say 10 minutes) prior to the start time of the appointment. In any case, the comparison can inform how late the user is estimated to be, which in turn can inform whether this is significant enough to warrant further action. In some embodiments, the provider has set a rescheduling threshold that indicates a delay at which to trigger rescheduling an appointment based on late user arrival. For instance, if the threshold is set at 15 minutes and a late user is expected to arrive only 10 minutes late, the threshold is not exceeded and this may not be significant enough to prompt a reschedule of the appointment. In other words, the provider might have a general policy that it will see patients up to 15 minutes after the start time of their scheduled appointment, but will force a reschedule if the user is 15 or more minutes late. The provider can define a rescheduling threshold accordingly. In some embodiments, there are different thresholds to use in different situations. For instance, this threshold might be set higher in the earlier parts of the day (say, before noontime) and shorter in the later parts of the day (say, after noontime) on account that as the day goes, the provider is progressively more likely to be running later and operating on a delay in seeing users at their scheduled times.

Based on the comparison at 308, it is determined (310) whether to attempt a reschedule of the appointment. This can include determining whether the difference between the estimated arrival time and the initial anticipated arrival time for the scheduled appointment exceeds the threshold, for instance. If the threshold is not exceeded, then the provider may be willing to accommodate the delay without rescheduling the user's appointment (though the appointment time might be updated in the provider's appointment software to reflect the later start time, if desired). In any case, if it is determined not to attempt a reschedule (310, N), the process loops back to 304 to (potentially) process a next upcoming appointment.

Otherwise, it is determined to attempt rescheduling the appointment (310, Y). and the process proceeds to FIG. 3B. The attempts to reschedule the user's appointment may be based on the estimated arrival time and initial anticipated arrival time for the scheduled appointment (since the provider threshold was exceeded) as well as the schedule of appointments that is maintained in the blockchain. Rescheduling the appointment includes at least one change to make to the schedule of appointments, for instance at least a modification to the scheduled appointment to move/rescheduling or potentially cancel the appointment at the least.

Referring to FIG. 3B, the process attempts (312) to reschedule the appointment based on mutual user and provider availability. An example such process to attempt this is described with reference to FIG. 3C.

Referring to FIG. 3C, the process checks (330) for mutual availability of the user and the service provider within some upcoming timeframe, as informed by the schedule of appointments. The upcoming timeframe could be a defined timeframe extending a defined amount of time out from a current time. For instance, the timeframe could be the rest of the current day, the current day and the next business day, or some other timeframe. The timeframe could be defined by the doctor and/or the user, in examples.

Based on the checking, the process determines (332) whether there is an open appointment available with the provider that which also works for the user based on the user's current schedule, and within the upcoming timeframe. If not (332, N), the process ends (e.g. by returning to FIG. 3B). Otherwise (332, Y), there is an open such appointment and the process proceeds by rescheduling (334) the user's scheduled appointment to the later time of the open appointment based on mutual availability between the service provider and the user as informed by the schedule of appointments, and records (336) this change to the schedule of appointments as transaction(s) on the blockchain, then ends (e.g. by returning to FIG. 3B).

Returning to FIG. 3B, after the attempt to reschedule based on user-provider mutual availability, the process determines (314) whether the attempt was successful. If so (314, Y), the process optionally performs re-navigating (315) the user based on the rescheduling, and returns to FIG. 3A to process further upcoming appointments when appropriate. In this regard, the monitoring (306) may be way of navigation software navigating the user to the appointment location as a set destination. Based on rescheduling the scheduled appointment to the later time, the process optionally at 315 alerts the user via the navigation software of a change in the set destination. For instance, the navigation may be cancelled to remove the appointment location as a current destination on account that the appointment was rescheduled to a later time. Additionally or alternatively the process could route the user to a different destination, such as the user's home, work, or location where the user was previous to commencing travel to the appointment.

If instead it is determined at 314 that the attempt was not successful (314, N), then rescheduling in the upcoming timeframe without potential swapping or displacing other appointments is not possible. The process therefore proceeds by attempting (316) to reschedule by swapping the scheduled appointment with a later appointment. An example such process to attempt this is described with reference to FIG. 3D.

Referring to FIG. 3D, the process attempts to swap the user's scheduling appointment, scheduled at a first time, with another appointment scheduled at a second time that is later than the first time and later than the estimated arrival time of the user to the appointment location. Thus, the process checks (340) for scheduled other appointment(s) between the service provider and other user(s) to swap for the scheduled appointment held by the user. When considering whether another appointment is a candidate to swap with the user's scheduled appointment, the process may take into account a location of the another user (that has the another appointment with the provider), and specifically whether that another user is, or will be, at the appointment location early, i.e. by or before the first time at which the late user's appointment is scheduled. If that another user is already, or will be, at the appointment location before the first time, then the another user's appointment can be swapped with the late user's appointment. The process therefore determines (342) whether to swap the scheduled appointment, scheduled at the first time, with another appointment scheduled at a second time, the second time being later than the first time and later than the estimated arrival time of the user. If not (342, N), the process ends (e.g., by returning to FIG. 3B). Otherwise (342, Y) the process swaps (344) the scheduled appointment of the user with the another appointment, rescheduling the scheduled appointment to the second time and rescheduling the another appointment to the first time, and records (346) these changes to the schedule of appointments as one or more transactions on the blockchain, then ends (e.g. by returning to FIG. 3B).

Returning to FIG. 3B, after the attempt to swap with another appointment, the process determines (318) whether the attempt was successful. If so (318, Y), the process optionally performs re-navigating (315) the user based on the rescheduling, and returns to FIG. 3A to process further upcoming appointments when appropriate. Otherwise (318, N), the process attempts (320) to reschedule the scheduled appointment by an incentivized rescheduling approach. An example such process is described with reference to FIG. 3E.

Referring to FIG. 3E, the process identifies (350) one or more other users to which to offer a respective incentive for incentivized rescheduling. The one or more other users each hold a respective appointment with the service provider scheduled at a respective second time that is later than the first time (the time of the late user's scheduled appointment) and also later than the estimated arrival time of the user. The identification of the one or more other users can be based on scheduling flexibility of the one or more other users. For example, some users may, by way of their schedule and/or preference, have more flexibility than other users to reschedule appointments. Users may be able to indicate a degree of willingness to participate in incentivized rescheduling, in some examples. In any case, each of the one or more other users can be identified based on mutual availability between the service provider and that other user. The availability to reschedule the appointment held by that other user can be determined by prompting the other user and/or provider to indicate availability and/or can be automatically informed by the schedule of appointments that is maintained. In situations where a user accepts an incentive to reschedule, the changes to the schedule of appointments can include a modification to the scheduled appointment held by that other user to reschedule the appointment held by the other user from the second time to another time, thereby allowing the scheduled appointment of the late user to be scheduled at the second time, i.e. the time of the other user's appointment before being rescheduled. It is noted, however, that incentivized rescheduling need not involve a reschedule of the other user's appointment, for instance if there is no upcoming mutual availability of the other user and the provider to reschedule. In this situation, a later attempt may be made to reschedule the other user.

After identifying the other user(s) to which to offer incentivized rescheduling, the process determines (352) a respective incentive to offer each such other user. The incentive to offer to another user can be determined based on a quantification of an inconvenience to the other user if the user accepts and can be compensation in the form of money or any other incentive(s). For instance, the compensation could be at least a fixed amount of compensation in exchange for the inconvenience of relinquishing the other user's appointment in favor of the late user. Additionally, in situations where the other user is able to reschedule his or her original appointment to a different time, an example quantification can be based on a measure of how far removed from the original appointment time the system proposes to reschedule the other user's appointment. The incentive can be determined as a function of that quantification of inconvenience to the other user for rescheduling the appointment that the other user held. By way of specific example, the incentive could be determined as k*(n+1), where k is a fixed amount of compensation and n is a number of days by which the original appointment is proposed to be pushed out. Taking an example in which k=$10, then the incentive to offer would be $10*(1+0)=$10 if the original appointment of the other user is proposed for rescheduling later the same day, and $10*(1+3)=$40 if the original appointment of the other user is proposed for rescheduling 3 days after the original appointment.

After the incentive(s) to offer are determined, the process offers (354) to each other user of the one or more other users the respective incentive determined for that other user, in exchange for relinquishing the respective appointment held by the other user. The process may prompt the other user(s) to accept or reject the incentivized rescheduling offer. The process then determines (356) whether any of the other user(s) accepted. If all of the other user(s) reject (or at least fail to accept) the offer presented to them, this may be considered nonacceptance. In some examples, this can trigger repeating, one or more times, revising the incentive(s) and reoffering the revised incentive(s) to the other users (358). This can have an advantage in situations where another user is willing to relinquish his or her appointment but for a greater incentive than originally offered.

If it is determined that there was no acceptance after offering the incentive(s) the appropriate one or more times [(356, N) and (358, N)], then the process ends (e.g., by returning to FIG. 3B). Otherwise (356, Y), at least one other user accepted an offer presented to the user. If more than one other user accepted, then the process may proceed with respect to the earliest-accepting other user. Accordingly, based on receiving, from an accepting other user of the one or more other users, an acceptance of the incentive offered to the accepting other user, the process proceeds by rescheduling (360) appointment(s), recording (362) these changes to the schedule of appointments as one or more transactions on the blockchain, then ending (e.g., by returning to FIG. 3B). Specifically, as part of the changes to make to the schedule of appointments, the process at 360 can reschedule the scheduled appointment (i.e., held by the late user) to the time (a ‘second time’) of the respective appointment held by the accepting other user. If the incentivized rescheduling also includes rescheduling the other user's original appointment to a later time, then the changes also include modifying the scheduled appointment held by the other user, e.g., rescheduling that appointment to another time.

In examples, the incentive can be conveyed to the other user via online/digital transaction(s). In the case of compensation, one or both of the user and the accepting user can utilize cryptocurrency accounts to send/receive the compensation. For instance, the user and the accepting other user can each have a respective cryptocurrency account, and

wherein a process can, based on receiving from the accepting user the incentive offered to the accepting other user, initiate conveyance of the incentive from the cryptocurrency account of the user to the cryptocurrency account of the other user.

Returning to FIG. 3B, after the attempted incentivized rescheduling, the process determines (322) whether the attempt was successful. If so (322, Y), the process optionally performs re-navigating (315) the user based on the rescheduling, and returns to FIG. 3A to process further upcoming appointments when appropriate. Otherwise (322, N), the attempts to reschedule were unsuccessful. At this point, the scheduled appointment can be cancelled (optionally re-navigating the user back home or to another location). The process then returns to FIG. 3A to process to process further upcoming appointments when appropriate.

It is noted with respect to FIG. 3B that the different types of attempts to reschedule (312, 316, 320) may be performed in a different order and/or one or more types of attempts may be omitted. It may, for instance, be preferable to first attempt an incentivized reschedule and then attempt an appointment swap only if the incentivized reschedule fails, for instance.

Although various examples are provided, variations are possible without departing from a spirit of the claimed aspects.

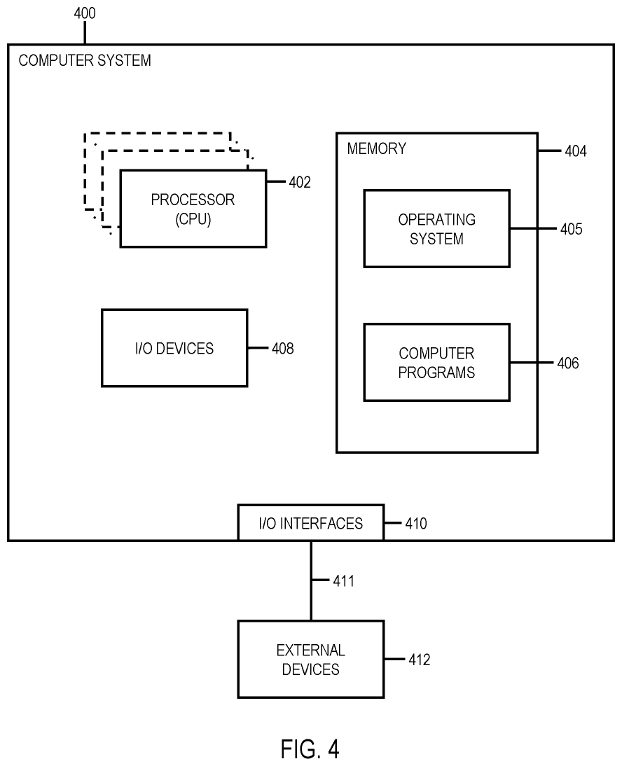

Processes described herein may be performed singly or collectively by one or more computer systems, such as one or more systems of or used by service providers, one or more systems of or used by users with appointments scheduled with service providers, or a combination of the foregoing, as examples. FIG. 4 depicts one example of such a computer system and associated devices to incorporate and/or use aspects described herein. A computer system may also be referred to herein as a data processing device/system, computing device/system/node, or simply a computer. The computer system may be based on one or more of various system architectures and/or instruction set architectures, such as those offered by Intel Corporation (Santa Clara, Calif., USA) or ARM Holdings plc (Cambridge, England, United Kingdom), as examples.

FIG. 4 shows a computer system 400 in communication with external device(s) 412. Computer system 400 includes one or more processor(s) 402, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 402 can also include register(s) to be used by one or more of the functional components. Computer system 400 also includes memory 404, input/output (I/O) devices 408, and I/O interfaces 410, which may be coupled to processor(s) 402 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 404 can be or include main or system memory (e.g., Random Access Memory) used in the execution of program instructions, storage device(s) such as hard drive(s), flash media, or optical media as examples, and/or cache memory, as examples. Memory 404 can include, for instance, a cache, such as a shared cache, which may be coupled to local caches (examples include L1 cache, L2 cache, etc.) of processor(s) 402. Additionally, memory 404 may be or include at least one computer program product having a set (e.g., at least one) of program modules, instructions, code or the like that is/are configured to carry out functions of embodiments described herein when executed by one or more processors.

Memory 404 can store an operating system 405 and other computer programs 406, such as one or more computer programs/applications that execute to perform aspects described herein. Specifically, programs/applications can include computer readable program instructions that may be configured to carry out functions of embodiments of aspects described herein.

Examples of I/O devices 408 include but are not limited to microphones, speakers, Global Positioning System (GPS) devices, cameras, lights, accelerometers, gyroscopes, magnetometers, sensor devices configured to sense light, proximity, heart rate, body and/or ambient temperature, blood pressure, and/or skin resistance, and activity monitors. An I/O device may be incorporated into the computer system as shown, though in some embodiments an I/O device may be regarded as an external device (412) coupled to the computer system through one or more I/O interfaces 410.

Computer system 400 may communicate with one or more external devices 412 via one or more I/O interfaces 410. Example external devices include a keyboard, a pointing device, a display, and/or any other devices that enable a user to interact with computer system 400. Other example external devices include any device that enables computer system 400 to communicate with one or more other computing systems or peripheral devices such as a printer. A network interface/adapter is an example I/O interface that enables computer system 400 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems (BLUETOOTH is a registered trademark of Bluetooth SIG, Inc., Kirkland, Wash., U.S.A.).

The communication between I/O interfaces 410 and external devices 412 can occur across wired and/or wireless communications link(s) 411, such as Ethernet-based wired or wireless connections. Example wireless connections include cellular, Wi-Fi, Bluetooth®, proximity-based, near-field, or other types of wireless connections. More generally, communications link(s) 411 may be any appropriate wireless and/or wired communication link(s) for communicating data.

Particular external device(s) 412 may include one or more data storage devices, which may store one or more programs, one or more computer readable program instructions, and/or data, etc. Computer system 400 may include and/or be coupled to and in communication with (e.g., as an external device of the computer system) removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media.

Computer system 400 may be operational with numerous other general purpose or special purpose computing system environments or configurations. Computer system 400 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

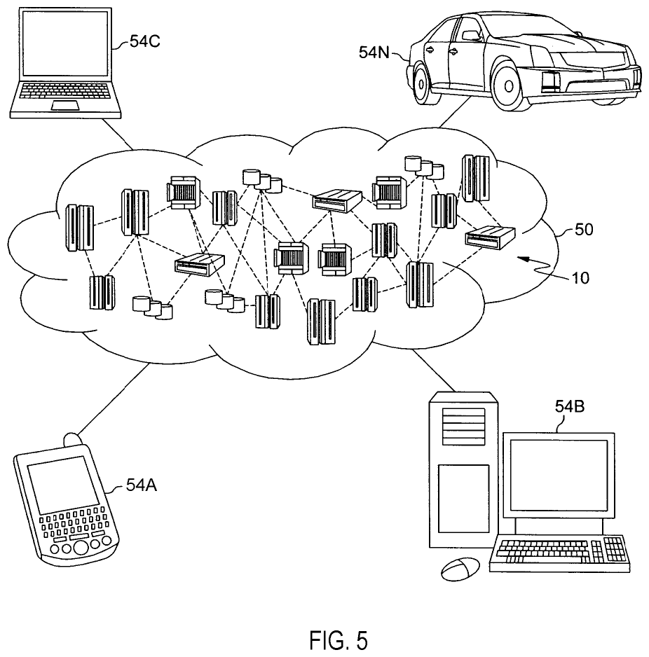

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

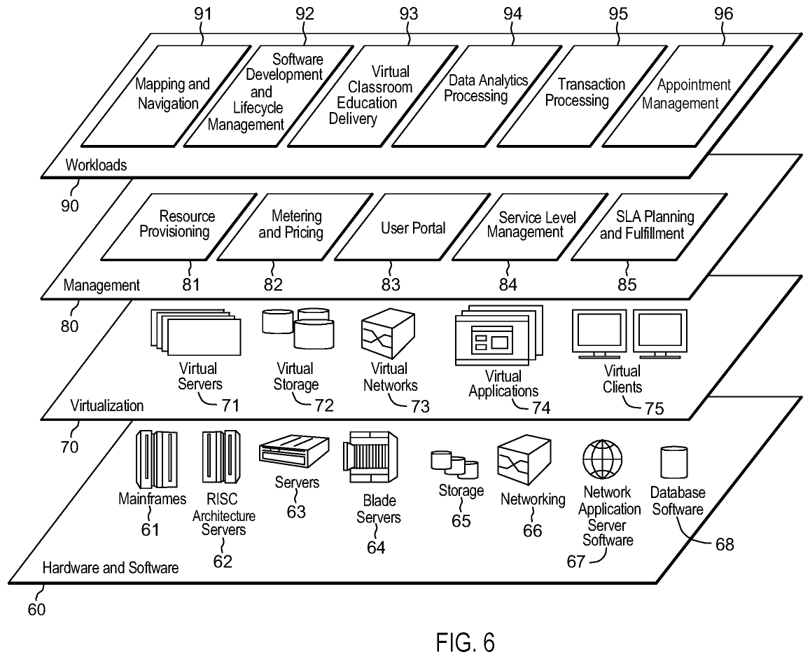

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and appointment management 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
maintaining, in a blockchain network with which a service provider and a collection of users engage, a schedule of appointments between the service provider and individual users of the collection of users; and
managing appointment scheduling between the service provider and one or more users of the collection of users via recordation of blockchain transactions on a blockchain of the blockchain network, the appointment scheduling comprising changing existing appointments, and the managing comprising:
monitoring travel of a user to an appointment location at which a scheduled appointment between the service provider and the user is to occur, the monitoring providing an estimated arrival time of the user to the appointment location;
based on the estimated arrival time, an initial anticipated arrival time for the scheduled appointment, and the schedule of appointments, determining at least one change to make to the schedule of appointments, the at least one change comprising a modification to the scheduled appointment; and
recording the at least one change to the schedule of appointments as one or more transactions on the blockchain.

2. The method of claim 1, further comprising maintaining a rescheduling threshold, set by the service provider, indicating a delay at which to trigger rescheduling an appointment based on late user arrival, wherein the determining the scheduled appointment is to be rescheduled is based a difference between the estimated arrival time and the initial anticipated arrival time for the scheduled appointment exceeding the threshold, and wherein the determining the at least one change is performed based further on determining that the scheduled appointment is to be rescheduled, wherein the modification to the scheduled appointment comprises rescheduling the scheduled appointment.

3. The method of claim 2, wherein the rescheduling reschedules the scheduled appointment to a later time based on mutual availability between the service provider and the user as informed by the schedule of appointments.

4. The method of claim 1, wherein the at least one change to make to the schedule of appointments comprises swapping the scheduled appointment, scheduled at a first time, with another appointment scheduled at a second time, the second time being later than the first time and later than the estimated arrival time of the user, the another appointment being between the service provider and another user, wherein the swapping reschedules the scheduled appointment to the second time and reschedules the another appointment to the first time, and wherein the determining the at least one change is based further on a location of the another user prior to the first time.

5. The method of claim 1, wherein the scheduled appointment is scheduled at a first time, and wherein determining the at least one change comprises:
identifying one or more other users to which to offer a respective incentive for incentivized rescheduling, the one or more other users each holding a respective appointment with the service provider scheduled at a respective second time that is later than the first time and later than the estimated arrival time of the user, wherein the identifying the one or more other users is based on scheduling flexibility of the one or more other users;
offering, to each other user of the one or more other users, the respective incentive in exchange for relinquishing the respective appointment held by the other user; and
based on receiving, from an accepting other user of the one or more other users, an acceptance of the incentive offered to the accepting other user, rescheduling the scheduled appointment to the second time of the respective appointment held by the accepting other user.

6. The method of claim 5, wherein each other user of the one or more other users is identified based on mutual availability between the service provider and the other user, as informed by the schedule of appointments, to reschedule the appointment held by the other user, wherein the at least one change further comprises a modification to the scheduled appointment held by the other user, and wherein the method further comprises rescheduling of the appointment held by the other user to another time.

7. The method of claim 5, further comprising determining the incentive to offer to the accepting other user as a function of a quantification of an inconvenience to the accepting other user for rescheduling the appointment held by the accepting other user.

8. The method of claim 5, wherein the user and the accepting other user each have a respective cryptocurrency account, and wherein the method further comprises, based on receiving from the accepting user the incentive offered to the accepting other user, initiating conveyance of the incentive from the cryptocurrency account of the user to the cryptocurrency account of the other user.

9. The method of claim 1, wherein the monitoring travel of the user is by way of navigation software navigating the user to the appointment location as a set destination, and wherein, based on rescheduling the scheduled appointment to the later time, the method further comprises alerting the user via the navigation software of a change in the set destination.

10. A computer system comprising:
a memory; and
a processor in communication with the memory, wherein the computer system is configured to perform a method comprising:
maintaining, in a blockchain network with which a service provider and a collection of users engage, a schedule of appointments between the service provider and individual users of the collection of users; and
managing appointment scheduling between the service provider and one or more users of the collection of users via recordation of blockchain transactions on a blockchain of the blockchain network, the appointment scheduling comprising changing existing appointments, and the managing comprising:
monitoring travel of a user to an appointment location at which a scheduled appointment between the service provider and the user is to occur, the monitoring providing an estimated arrival time of the user to the appointment location;
based on the estimated arrival time, an initial anticipated arrival time for the scheduled appointment, and the schedule of appointments, determining at least one change to make to the schedule of appointments, the at least one change comprising a modification to the scheduled appointment; and
recording the at least one change to the schedule of appointments as one or more transactions on the blockchain.

11. The computer system of claim 10, wherein the method further comprises maintaining a rescheduling threshold, set by the service provider, indicating a delay at which to trigger rescheduling an appointment based on late user arrival, wherein the determining the scheduled appointment is to be rescheduled is based a difference between the estimated arrival time and the initial anticipated arrival time for the scheduled appointment exceeding the threshold, and wherein the determining the at least one change is performed based further on determining that the scheduled appointment is to be rescheduled, wherein the modification to the scheduled appointment comprises rescheduling the scheduled appointment.

12. The computer system of claim 11, wherein the rescheduling reschedules the scheduled appointment to a later time based on mutual availability between the service provider and the user as informed by the schedule of appointments.

13. The computer system of claim 10, wherein the at least one change to make to the schedule of appointments comprises swapping the scheduled appointment, scheduled at a first time, with another appointment scheduled at a second time, the second time being later than the first time and later than the estimated arrival time of the user, the another appointment being between the service provider and another user, wherein the swapping reschedules the scheduled appointment to the second time and reschedules the another appointment to the first time, and wherein the determining the at least one change is based further on a location of the another user prior to the first time.

14. The computer system of claim 10, wherein the scheduled appointment is scheduled at a first time, and wherein determining the at least one change comprises:
identifying one or more other users to which to offer a respective incentive for incentivized rescheduling, the one or more other users each holding a respective appointment with the service provider scheduled at a respective second time that is later than the first time and later than the estimated arrival time of the user, wherein the identifying the one or more other users is based on scheduling flexibility of the one or more other users;
offering, to each other user of the one or more other users, the respective incentive in exchange for relinquishing the respective appointment held by the other user; and
based on receiving, from an accepting other user of the one or more other users, an acceptance of the incentive offered to the accepting other user, rescheduling the scheduled appointment to the second time of the respective appointment held by the accepting other user.

15. The computer system of claim 14, wherein the user and the accepting other user each have a respective cryptocurrency account, and wherein the method further comprises, based on receiving from the accepting user the incentive offered to the accepting other user, initiating conveyance of the incentive from the cryptocurrency account of the user to the cryptocurrency account of the other user.

16. The computer system of claim 10, wherein the monitoring travel of the user is by way of navigation software navigating the user to the appointment location as a set destination, and wherein, based on rescheduling the scheduled appointment to the later time, the method further comprises alerting the user via the navigation software of a change in the set destination.

17. A computer program product comprising:
a computer readable storage medium readable by a processing circuit and storing instructions for execution by the processing circuit for performing a method comprising:
maintaining, in a blockchain network with which a service provider and a collection of users engage, a schedule of appointments between the service provider and individual users of the collection of users; and
managing appointment scheduling between the service provider and one or more users of the collection of users via recordation of blockchain transactions on a blockchain of the blockchain network, the appointment scheduling comprising changing existing appointments, and the managing comprising:
monitoring travel of a user to an appointment location at which a scheduled appointment between the service provider and the user is to occur, the monitoring providing an estimated arrival time of the user to the appointment location;
based on the estimated arrival time, an initial anticipated arrival time for the scheduled appointment, and the schedule of appointments, determining at least one change to make to the schedule of appointments, the at least one change comprising a modification to the scheduled appointment; and
recording the at least one change to the schedule of appointments as one or more transactions on the blockchain.

18. The computer program product of claim 17, wherein the method further comprises maintaining a rescheduling threshold, set by the service provider, indicating a delay at which to trigger rescheduling an appointment based on late user arrival, wherein the determining the scheduled appointment is to be rescheduled is based a difference between the estimated arrival time and the initial anticipated arrival time for the scheduled appointment exceeding the threshold, wherein the determining the at least one change is performed based further on determining that the scheduled appointment is to be rescheduled, wherein the modification to the scheduled appointment comprises rescheduling the scheduled appointment, and wherein the rescheduling reschedules the scheduled appointment to a later time based on mutual availability between the service provider and the user as informed by the schedule of appointments.

19. The computer program product of claim 17, wherein the at least one change to make to the schedule of appointments comprises swapping the scheduled appointment, scheduled at a first time, with another appointment scheduled at a second time, the second time being later than the first time and later than the estimated arrival time of the user, the another appointment being between the service provider and another user, wherein the swapping reschedules the scheduled appointment to the second time and reschedules the another appointment to the first time, and wherein the determining the at least one change is based further on a location of the another user prior to the first time.

20. The computer program product of claim 17, wherein the scheduled appointment is scheduled at a first time, and wherein determining the at least one change comprises:
identifying one or more other users to which to offer a respective incentive for incentivized rescheduling, the one or more other users each holding a respective appointment with the service provider scheduled at a respective second time that is later than the first time and later than the estimated arrival time of the user, wherein the identifying the one or more other users is based on scheduling flexibility of the one or more other users;
offering, to each other user of the one or more other users, the respective incentive in exchange for relinquishing the respective appointment held by the other user; and
based on receiving, from an accepting other user of the one or more other users, an acceptance of the incentive offered to the accepting other user, rescheduling the scheduled appointment to the second time of the respective appointment held by the accepting other user.
